(19) United States
(12) Patent Application Publication
(10) Pub. No.: US 2023/0166140 A1
(43) Pub. Date: Jun. 1, 2023

(54) AN EXTINGUISHING SYSTEM AND AN EXTINGUISHING METHOD

(71) Applicant: FIRESEA EQUIPMENT OY, HELSINKl (FI)

(72) Inventors: Jarmo JÄRVINEN, LAHTI (FI); Ari MATTILA, HELSINKI (FI)

(21) Appl. No.: 17/921,572

(22) PCT Filed: Feb. 16, 2021
(86) PCT No.: PCT/FI2021/050107

§ 371 Date: Oct. 26, 2022

(30) Foreign Application Priority Data
Apr. 27, 2020 (FI) 20205418

(51) Int. Cl. A62C 3/16; A62C 3/07

(52) U.S. Cl. CPC A62C 3/16; A62C 3/07

(57) ABSTRACT

An extinguishing system includes a wall element for surrounding an object on fire. The object can be for example an electric or hybrid car that includes a battery. A lower edge of the wall element is configured to provide a sealed joint between the lower edge of the wall element and a surface on which the object on fire is located. The wall element and the surface constitute a pool that can be filled with firefighting water to extinguish the fire in the object.

### TECHNICAL FIELD

The disclosure relates generally to extinguishing technology. More particularly, the disclosure relates to an extinguishing system that can be used for extinguishing e.g. a fire in an electric or hybrid vehicle comprising a battery. Furthermore, the disclosure relates to an extinguishing method.

### BACKGROUND

Over the last decade, development of electric and hybrid vehicles has significantly changed the car industry globally. The development has been mainly driven by the fast development of battery technology. However, a fire risk and hazard associated with high-energy batteries has become a significant safety concern for electric and hybrid vehicles. Thermal runaway or fire can occur as a result of extreme abuse conditions that may be results of faulty operation and/or traffic accidents. Failure of a battery may then be accompanied by release of toxic gases, fire, jet flames, and/or explosion. Extinguishing a fire on a battery of an electric or hybrid vehicle can be challenging because a burning battery inside a vehicle can be inaccessible to externally applied suppressant and can re-ignite without sufficient cooling. As a corollary, an excessive amount of suppression agent is needed to cool the battery, extinguish the fire, and prevent re-ignition. Thus, in many cases, there is a need to submerge a burning electric or hybrid vehicle into water in order to reliably extinguish the fire.

A process in which a burning electric or hybrid vehicle is submerged into water is typically carried out so that a sufficiently large pool containing a sufficient amount of water is brought in the vicinity of the electric or hybrid vehicle and thereafter the electric or hybrid vehicle is lifted with a suitable crane into the pool. The above-mentioned process can be however difficult, unless impossible, in a case in which a burning electric or hybrid vehicle is in a parking hall, in a ship, or in another place where room is limited so that it is challenging, unless impossible, to bring a sufficiently strong crane and a sufficiently large water pool near to a burning electric or hybrid vehicle.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric point, a straight or curved geometric line, a planar or non-planar geometric surface, a geometric space, or any other geometric entity that is zero, one, two, or three dimensional.

In accordance with the invention, there is provided a new extinguishing system that comprises a wall element for surrounding an object on fire, e.g. a burning electric or hybrid vehicle. A lower edge of the wall element is configured to provide a sealed joint between the lower edge of the wall element and a surface on which the object on fire is located. Thus, the wall element and the surface constitute a pool for containing firefighting water covering at least partly the object on fire.

The above-mentioned wall element is made of a flexible membrane that is arranged to form one or more cavities for stiffening the wall element when being filled with filler material. The extinguishing system comprises a pressurized bottle for supplying intumescent material to the one or more cavities, wherein the intumescent material acts as the filler material The wall element can be erected around the burning object and firefighting water can be pumped to the room limited by the wall element. Therefore, the extinguishing system can be used in parking halls, ships, and other places where room is limited. Furthermore, the wall element prevents the firefighting water from spreading to the environment in an uncontrolled way and thus the wall element makes it possible to collect the used firefighting water that may contain environmentally harmful substances and/or even poisonous substances. Thereafter, the used firefighting water can be delivered to appropriate further processing, e.g. to a plant for toxic and dangerous waste treatment.

In accordance with the invention, there is provided also a new method for extinguishing a fire in an object. The method comprises:
arranging a wall element of an extinguishing system according to the invention to surround the object, and
conducting firefighting water to a pool constituted by the wall element and a surface on which the object is located,

wherein the wall element is made of flexible membrane arranged to form one or more cavities, and the method comprises filling the one or more cavities with filler material to stiffen the wall element. Furthermore, the method comprises supplying, from a pressurized bottle, intumescent material to one or more cavities of the above-mentioned wall element to stiffen the wall element.

In an exemplifying case in which the object is a vehicle, the firefighting water is advantageously conducted to a bodywork of the vehicle with a nozzle directing a water jet to inside the bodywork of the vehicle. When the bodywork is being filled by the firefighting water, a part of the firefighting water leaks out to the pool constituted by the wall element and a surface on which the vehicle is located. The water can be conducted to inside the bodywork for example via a broken or opened window of the vehicle.

Exemplifying and non-limiting embodiments are described in accompanied dependent claims.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of unrecited features. The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF FIGURES

Exemplifying and non-limiting embodiments and their advantages are explained in greater detail below in the sense of examples and with reference to the accompanying drawings, in which:

FIGS. 1a and 1b illustrate an extinguishing system according to an exemplifying and non-limiting embodiment,

FIG. 2 illustrates an extinguishing system according to an exemplifying and non-limiting embodiment,

FIG. 3 illustrates an extinguishing system according to an exemplifying and non-limiting embodiment, and

FIG. 4 shows a flowchart of a method according to an exemplifying and non-limiting embodiment for extinguishing a fire in an object.

### DESCRIPTION OF EXEMPLIFYING AND NON-LIMITING EMBODIMENTS

The specific examples provided in the description below should not be construed as limiting the scope and/or the applicability of the accompanied claims. Lists and groups of examples provided in the description are not exhaustive unless otherwise explicitly stated.

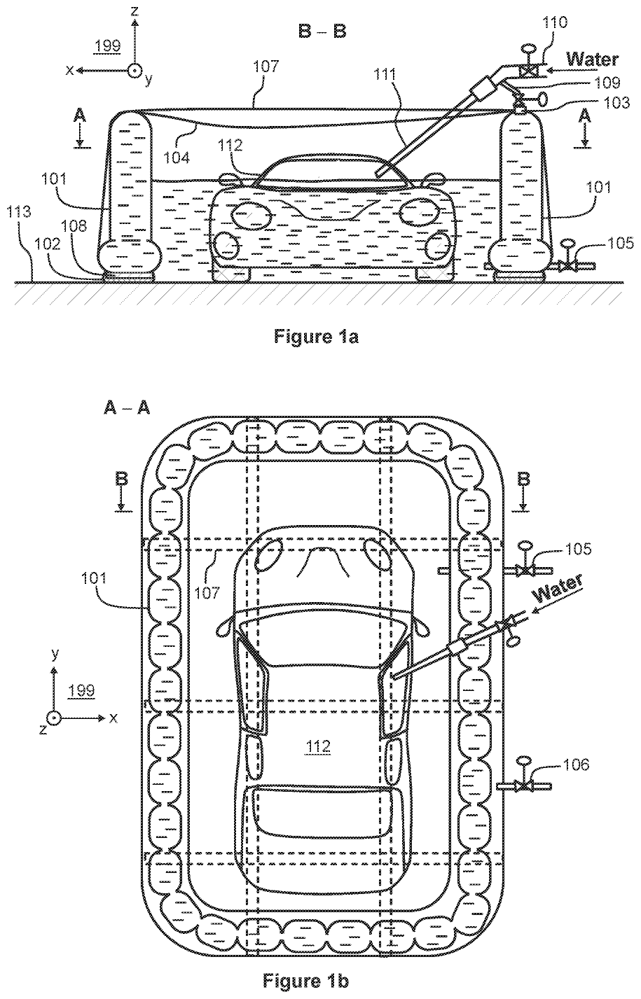

FIGS. 1a and 1b illustrate an extinguishing system according to an exemplifying and non-limiting embodiment. FIG. 1a shows a section taken along a line B-B shown in FIG. 1b, wherein the geometric section plane is parallel with the xz-plane of a coordinate system 199. FIG. 1b shows a section taken along a line A-A shown in FIG. 1a, wherein the geometric section plane is parallel with the xy-plane of the coordinate system 199. The extinguishing system comprises a wall element 101 for surrounding an object 112 on fire. In the exemplifying situation shown in FIGS. 1a and 1b, the object 112 is an electric or hybrid car. In this exemplifying case, a lower edge of the wall element 101 comprises sealing material 102 for providing a sealed joint between the lower edge of the wall element 101 and a surface 113 on which electric or hybrid car is located. The sealing material 102 can be for example soft closed-cell polymer foam or some other suitable water impermeable soft material. It is also possible that the wall element 101 is made of material which, as such, is suitable for providing the sealed joint between the lower edge of the wall element 101 and the surface 113, and thus there is no need for separate sealing material. As illustrated in FIG. 1a, the wall element 101 and the surface 113 constitute a pool that can be filled with firefighting water to extinguish the fire in the electric or hybrid car. The firefighting water can be e.g. normal tap water available from hydrants, or the firefighting water may contain added chemicals for improving its ability to extinguish fire.

In the exemplifying extinguishing system illustrated in FIGS. 1a and 1b, the wall element 101 is made of a flexible membrane that is configured to form cavities for stiffening the wall element 101 when the cavities are filled with filler material. In this exemplifying case, the wall element 101 comprises a coupling element 103 for receiving pressurized water that acts as the filler material and stiffens the wall element 101. The flexible membrane can be for example fiber-reinforced polymer membrane. As shown in FIG. 1a, the water that fills the wall element 101 can be taken from a same water line 110 from which the firefighting water is taken. It is however also possible that a wall element of an extinguishing system according to an exemplifying embodiment comprises rigid elements joined each other so that the wall element is collapsible.

As shown in FIG. 1a, the firefighting water is conducted to the bodywork of the electric or hybrid car with a nozzle 111 that directs a water jet to inside the bodywork. The room delimited by the wall element 101 and by the surface 113 is at least partly filled with the firefighting water when the firefighting water leaks out from the electric or hybrid car.

The exemplifying extinguishing system illustrated in FIGS. 1a and 1b comprises a cover element 104 made of a flexible membrane and attached to the wall element 101 to close the room surrounded by the wall element 101. The cover element 104 can be made of for example fireproof fabric.

In the exemplifying extinguishing system illustrated in FIGS. 1a and 1b, a lower portion of the wall element 101 comprises an outlet valve 105 that is suitable for emptying the room surrounded by the wall element 101 from the firefighting water after the fire has been extinguished. In a typical case, the used firefighting water may contain environmentally harmful substances and/or even poisonous substances. Thus, it is advantageous that the used firefighting water can be collected in a controlled way and thereby a situation in which the used firefighting water leaks out to the environment can be avoided. Thereafter, the used firefighting water is advantageously delivered to appropriate post processing, e.g. to a plant for toxic and dangerous waste treatment. Thus, the possibility to handle the used firefighting water in a controlled way is a clear advantage of the extinguishing system according to the invention. The exemplifying extinguishing system illustrated in FIGS. 1a and 1b further comprises a valve 106 for emptying the wall element 101 from water.

The exemplifying extinguishing system illustrated in FIGS. 1a and 1b comprises tensioning straps extending between the upper edges of the wall element 101 and across an area surrounded by the wall element 101. In FIGS. 1a and 1b, one of the tensioning straps is denoted with a reference 107. The tensioning straps support the wall element 101 against pressure caused by the firefighting water.

In the exemplifying extinguishing system illustrated in FIGS. 1a and 1b, the lower edge of the wall element 101 comprises permanent magnet material 108 that attaches the wall element 101 to a surface on which the burning object is located when the surface is a surface of a structure, e.g. a deck of a ship, that comprises ferromagnetic material.

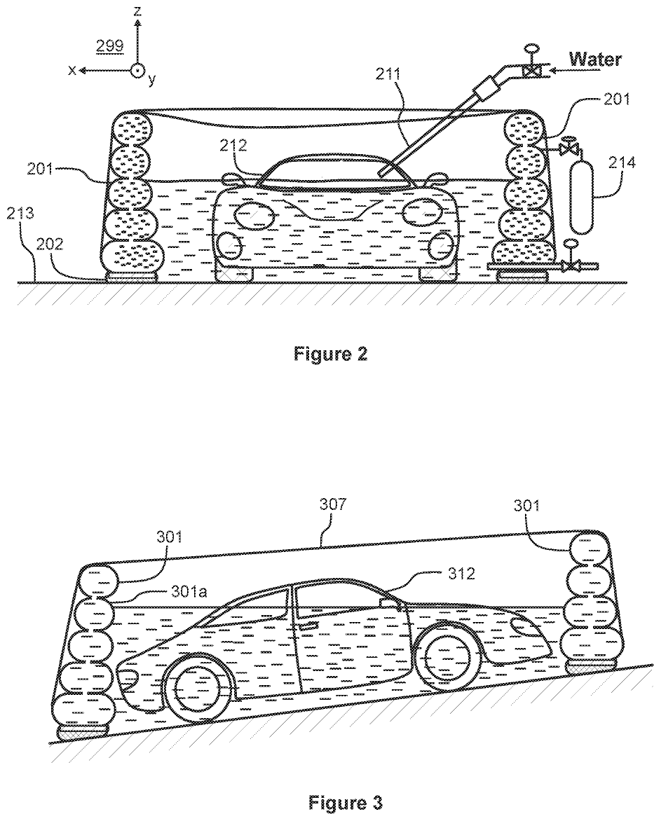

FIG. 2 shows a section view of an extinguishing system according to an exemplifying and non-limiting embodiment. The geometric section plane is parallel with the xz-plane of a coordinate system 299. The extinguishing system comprises a wall element 201 for surrounding an object 212 on fire. In the exemplifying situation shown in FIG. 2, the object 212 is an electric or hybrid car. In this exemplifying case, the lower edge of the wall element 201 comprises sealing material 202 for providing a sealed joint between the lower edge of the wall element 201 and a surface 213 on which electric or hybrid car is located. The wall element 201 is made of a flexible membrane that is configured to form cavities for stiffening the wall element when being filled with filler material. The exemplifying extinguishing system illustrated in FIG. 2 comprises a pressurized bottle 214 for supplying intumescent material to the cavities of the wall element 201. Thus, the intumescent material acts as the filler material that stiffens the wall element 201. The intumescent material can be for example polyurethane.

FIG. 3 shows a section view of an extinguishing system according to an exemplifying and non-limiting embodiment. In the exemplifying situation shown in FIG. 3, an object 312 under an extinguishing process is an electric or hybrid car that is located on an oblique surface. As the surface is oblique, the strongest force caused by firefighting water is directed to a portion 301a of a wall element 301. In this exemplifying case, a tensioning strap 307 is used to support the portion 301a of the wall element 301 against the force caused by the firefighting water.

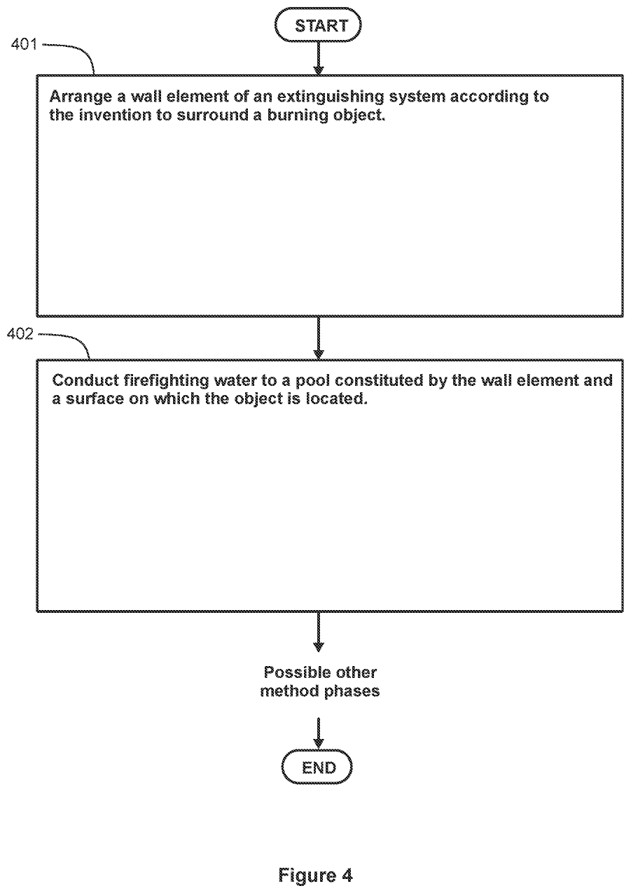

FIG. 4 shows a flowchart of a method according to an exemplifying and non-limiting embodiment for extinguishing fire in an object. The method comprises the following actions:
action 401: arranging a wall element of an extinguishing system according to an embodiment of the invention to surround the object, and
action 402: conducting firefighting water to a pool constituted by the wall element and by a surface on which the object is located.

In a method according to an exemplifying and non-limiting embodiment, the object is a vehicle and the firefighting water is conducted to the bodywork of the vehicle with a nozzle directing a water jet to inside the bodywork of the vehicle. In a method according to an exemplifying and non-limiting embodiment, the vehicle is an electric or hybrid car comprising a battery.

A method according to an exemplifying and non-limiting embodiment comprises filling one or more cavities of the above-mentioned wall element with filler material to stiffen the wall element. A method according to an exemplifying and non-limiting embodiment comprises supplying a part of the firefighting water to the one or more cavities of the wall element. In this exemplifying case, the part of the firefighting water acts as the above-mentioned filler material.

A method according to an exemplifying and non-limiting embodiment comprises supplying intumescent material to one or more cavities of the above-mentioned wall element to stiffen the wall element. In a method according to an exemplifying and non-limiting embodiment, the intumescent material is polyurethane.

A method according to an exemplifying and non-limiting embodiment comprises closing a room surrounded by the wall element and containing the object on fire with a cover element made of a flexible membrane, e.g. fireproof fabric.

A method according to an exemplifying and non-limiting embodiment comprises emptying the above-mentioned pool from the used firefighting water via an outlet valve after the fire has been extinguished. Advantageously, the method further comprises delivering the used firefighting water to appropriate post processing, e.g. to a plant for toxic and dangerous waste treatment.

A method according to an exemplifying and non-limiting embodiment comprises arranging one or more tensioning straps to extend between upper edges of the wall element and across an area surrounded by the wall element in order to support the wall element against forces caused by the firefighting water.

In a method according to an exemplifying and non-limiting embodiment, the lower edge of the wall element comprises permanent magnet material attaching the wall element to a surface on which the object is located when the surface is a surface of a structure comprising ferromagnetic material.

The specific examples provided in the description given above should not be construed as limiting the applicability and/or interpretation of the appended claims. It is to be noted that lists and groups of examples given in this document are non-exhaustive lists and groups unless otherwise explicitly stated.

1. An extinguishing system comprising a wall element for surrounding an object on fire, wherein a lower edge of the wall element is configured to provide a sealed joint between the lower edge of the wall element and a surface on which the object on fire is located, the wall element and the surface constituting a pool for containing firefighting water covering at least partly the object on fire, wherein the wall element is made of flexible membrane arranged to form one or more cavities for stiffening the wall element when being filled with filler material, and wherein the extinguishing system comprises a pressurized bottle for supplying intumescent material to the one or more cavities, the intumescent material acting as the filler material.

2. An extinguishing system according to claim 1, wherein the intumescent material is polyurethane.

3. An extinguishing system according to claim 1, wherein the extinguishing system comprises a cover element made of flexible membrane and attached to the wall element to close a room surrounded by the wall element.

4. An extinguishing system according to claim 1, wherein a lower portion of the wall element comprises an outlet valve for emptying a room surrounded by the wall element from the firefighting water.

5. An extinguishing system according to claim 1, wherein the extinguishing system comprises one or more tensioning straps extending between upper edges of the wall element and across an area surrounded by the wall element.

6. An extinguishing system according to claim 1, wherein the lower edge of the wall element comprises permanent magnet material for attaching the wall element to the surface on which the object on fire is located when the surface is a surface of a structure comprising ferromagnetic material.

7. A method for extinguishing fire in an object, the method comprising:
arranging the wall element of the extinguishing system of claim 1 to surround the object, and
conducting firefighting water to a pool constituted by the wall element and a surface on which the object is located,
wherein the wall element is made of flexible membrane arranged to form one or more cavities, and the method comprises filling the one or more cavities with filler material to stiffen the wall element, wherein the method comprises supplying, from a pressurized bottle, intumescent material to one or more cavities of the above-mentioned wall element to stiffen the wall element.

8. A method according to claim 7, wherein the object is a vehicle and the firefighting water is conducted to a bodywork of the vehicle with a nozzle directing a water jet to inside the bodywork of the vehicle.

9. A method according to claim 8, wherein the vehicle is an electric or hybrid car comprising a battery.

10. A method according to claim 7, wherein the method comprises emptying the pool from the firefighting water via an outlet valve after the fire has been extinguished.

11. The extinguishing system according to claim 2, wherein the extinguishing system comprises a cover element made of flexible membrane and attached to the wall element to close a room surrounded by the wall element.

12. The extinguishing system according to claim 2, wherein a lower portion of the wall element comprises an outlet valve for emptying a room surrounded by the wall element from the firefighting water.

13. The extinguishing system according to claim 3, wherein a lower portion of the wall element comprises an outlet valve for emptying a room surrounded by the wall element from the firefighting water.

14. The extinguishing system according to claim 2, wherein the extinguishing system comprises one or more tensioning straps extending between upper edges of the wall element and across an area surrounded by the wall element.

15. The extinguishing system according to claim 3, wherein the extinguishing system comprises one or more tensioning straps extending between upper edges of the wall element and across an area surrounded by the wall element.

16. The extinguishing system according to claim 4, wherein the extinguishing system comprises one or more tensioning straps extending between upper edges of the wall element and across an area surrounded by the wall element.

17. The extinguishing system according to claim 2, wherein the lower edge of the wall element comprises permanent magnet material for attaching the wall element to the surface on which the object on fire is located when the surface is a surface of a structure comprising ferromagnetic material.

18. The extinguishing system according to claim 3, wherein the lower edge of the wall element comprises permanent magnet material for attaching the wall element to the surface on which the object on fire is located when the surface is a surface of a structure comprising ferromagnetic material.

19. The extinguishing system according to claim 4, wherein the lower edge of the wall element comprises permanent magnet material for attaching the wall element to the surface on which the object on fire is located when the surface is a surface of a structure comprising ferromagnetic material.

20. The extinguishing system according to claim 5, wherein the lower edge of the wall element comprises permanent magnet material for attaching the wall element to the surface on which the object on fire is located when the surface is a surface of a structure comprising ferromagnetic material.
